(19) United States
(12) Patent Application Publication
(10) Pub. No.: US 2015/0234730 A1
(43) Pub. Date: Aug. 20, 2015

(54) SYSTEMS AND METHODS FOR PERFORMING SOFTWARE DEBUGGING

(71) Applicant: ZeroDee, Inc., Alexandria, VA (US)

(72) Inventors: Neil Craig Puthuff, McLean, VA (US); Stephan Scott Rose, Alexandria, VA (US)

(21) Appl. No.: 14/621,176

(22) Filed: Feb. 12, 2015

Related U.S. Application Data
(60) Provisional application No. 61/941,324, filed on Feb. 18, 2014.

(51) Int. Cl. G06F 11/36

(52) U.S. Cl. CPC G06F 11/3636

(57) ABSTRACT

Methods and systems for collecting execution trace data for software, analyzing execution data for software, and identifying defects in software. One method includes storing, by a processing unit, execution trace data for the software when the software is executed, storing, by the processing unit, source code for the software when the software is executed, storing, by the processing unit, a program image of the software when the software is executed, and replaying the execution of the software using the execution trace data, source code, and the program image.

### RELATED APPLICATIONS

This application claims priority to U.S. Provisional Application No. 61/941,324, filed Feb. 18, 2014, the entire content of which is incorporated by reference herein.

### BACKGROUND

Developers of computer software face a daunting challenge with conventional development tools and procedures. The conventional methods for debugging software and gaining an intimate understanding of how the software actually works involve a great deal of trial and error and require the developer to mentally simulate the software to understand how it works and more importantly, how it can fail.

One problem is that software defects, also known as ‘bugs’ are usually detected by their external symptoms. During software development, an engineer might notice from external symptoms that a software application is doing something incorrectly. This starts the process of debugging. The developer will then use their familiarity with the software to hypothesize what portion of the software might be the cause of the incorrect behavior. The go-to tool at this point is a Software Debugger, a tool which allows the developer to set a ‘trap’ on a specific condition that is suspected of causing the incorrect behavior. This is known as a breakpoint or a trigger condition.

The program is then run, often repeatedly until the incorrect behavior is exhibited or the debugger's capture condition is matched and a small amount of execution data is obtained. Frequently, the breakpoint will be hit and data captured, but the conditions were not exactly correct to capture the cause of the error. The developer will then modify the conditions to capture data and try again, proceeding in an iterative manner, learning more about what is not causing the error until the correct conditions for capturing the incorrect behavior at the moment it happens can be set up in the debugger.

This is a process that can take a few minutes or several hours for software defects that repeatedly exhibit the incorrect behavior, however some types of software bugs are transient in nature, and only happen under circumstances that are difficult to repeat. These types of defects can be extraordinarily difficult to resolve, and can take days or weeks of effort using highly skilled and expensive resources.

In a software development team environment, conventional software tools force developers to toil in isolation; incorrect behavior that is revealed by one developer is not automatically shared amongst other developers. The process of quality assurance (“QA”) and/or quality control (“QC”) testing and bug-reporting is similarly a time-consuming process; a bug has little chance of being fixed if it cannot be succinctly described in a series of ‘steps to reproduce this bug’ that reliably cause the bug to happen.

A bigger underlying problem with conventional methods of software debugging is that software developers can only fix the bugs they know about. Bugs with subtle symptoms or low recurrence rates are very likely to pass undetected during development and be shipped with the application at product release.

Furthermore, this fundamental lack of visibility causes much difficulty in gaining an understanding of how a software function or application actually works. Software developers are typically expected to take from 3 to 6 months to learn enough details about an unfamiliar software program to become proficient, and even longer to be considered experts.

### SUMMARY

Accordingly, embodiments of the invention provide debugging tools that automatically identify and categorize unique software behaviors that are exhibited at any point during software development (including QA and QC testing), and make the behavior available for software developers—as though they'd been painstakingly isolated by a conventional debugger. For example, for each function, a software developer can sue the stored unique behaviors to verify that the each intended path of the function is being executed properly. Furthermore, if more than a number of intended behaviors or paths are recorded, the developer can identify the bugs that are causing the unexpected paths. For example, if a software function includes three possible paths (e.g., three if/then statements), and the tools records five unique paths, a software developer can review each path and category the path as either valid and approved for invalid and a bug. Accordingly, a developer can identify a bug even without witnessing its occurrence.

These tools identify not only transient defects that rarely happen, but also defects with subtle symptoms and correct and expected behavior of software functions, regardless of when or where it happened, anywhere in development or test, anywhere within the enterprise.

Furthermore, once the behaviors are recorded they can be used to perform more than just software debugging. For example, the recorded unique behaviors can be studied by new developers to quickly familiarize themselves with software, reviewed by project managers to identify project status and performance of individuals programmers, replayed to performed tracing and other code analysis, and used to satisfy certification and other testing or quality requirements.

One embodiment of the invention provides a method of identifying a software execution sequence. The method includes initializing, by a processing unit, an identification variable when an object is instantiated. The method also includes, for each modification of the object, determining, by a processing unit, whether the modification has previously been performed based on stored data and, when the modification has not been previously performed, storing an identifier of the modification. The identifier can be based on at least one selected from the group consisting of (a) an offset into the object at which the modification is performed, (b) a size of the modification, (c) a count of previous modifications before the modification, and (d) an identifier of code performing the modification.

Another embodiment of the invention provides a method of displaying an execution path to a user. The method includes generating, by a processing unit, a screen illustrating an execution path for code, the screen illustrating a currently-executed instruction, a previously-executed instruction, and a next-executed instruction. The method can also include determining, with the processing unit, the next-executed instruction based on trace data previously stored for the code. Also, the method can include determining, with the processing unit, the next-executed instruction using an instruction set simulator, wherein the screen illustrates a likelihood of the next-executed instruction. In some embodiments, the screen also displays at least one program variable in a background of the screen.

A further embodiment of the invention provides a method of collecting execution trace data for software. The method includes identifying, by a processing unit, whether a data operand is marked as being externally reconstructable. The method also includes, when the data operand is marked as not being externally reconstructable, exporting trace data for the data operand to at least one data file and, when the data operand is marked as being externally reconstructable, not exporting trace data for the data operand to at least one data file. Identifying whether the data operand is marked as being externally reconstructable can include determining whether a bit is set for the data operand. The method can also include clearing the bit for the data operand to mark the data operand as not being externally reconstructable when the data operand is associated with a constant or clearing the bit for the data operand to mark the operand as not being externally reconstructable when the data operand includes reading a value from a memory location previously written, wherein trace data for the data operand was exported to at least one data file when the memory location was previously written. In addition, the method can include setting the bit for the data operand based on a value of a bit associated with at least one element associated with the data operand, wherein the bit associated with the at least one element is cleared if the at least one element is not externally reconstructable. Setting the bit for the data operand based on a value of a bit associated with at least one element associated with the data operand can include setting the value of the bit to the logical AND of the value of a bit associated with at least one two elements associated with the data operand.

Yet another embodiment of the invention provides a method of collecting execution trace data for software. The method includes receiving execution trace data from a data source at a cascade port, portioning the received execution trace data into a first portion and a second portion, routing the first portion to an internal memory for processing, and routing the second portion over a connector to a second cascade port.

Another embodiment of the invention provides a method of collecting execution trace data for software. The method includes receiving execution trace data at an expansion port associated with a first motherboard, portioning the received execution trace data into a first portion and a second portion, routing the first portion to an internal memory for processing, and routing the second portion to an expansion port associated with a second motherboard.

A further embodiment of the invention provides a method of identifying defects in software. The method includes executing a function included in the software along an execution path, determining, by a processing unit, an identifier for the execution path, wherein the identifier uniquely identifies the execution path as compared to other execution paths for the function, accessing a database of previously-determined identifiers associated with known execution paths of the function, and comparing the identifier with the database to determine if the database includes the identifier. The method also includes, when the database does not include the identifier, storing the identifier to the database and, when the database includes the identifiers, not storing the identifier to the database. The identifier can be based on at least one selected from the group consisting of a timing measurement, an execution address, an action performed on a data object, and real-time trace data. The method can also include storing execution data associated with the path of execution associated with the identifier and using the stored execution data to replay the path of execution. In addition, the method can include allowing a user to review each identifier included in the database and receive a classification of each identifier as being associated with a valid execution path or a defective execution path.

Yet another embodiment of the invention provides a method of managing a software development project. The method includes automatically collecting information associated with each function included in software, the information including function execution path identifier, function execution path assessment, and developer identifier, and allowing a user to query for the automatically collected information and provide the results of the query in a graphical user interface.

Another embodiment of the invention provides a method of managing a software development project. The method includes automatically collecting information associated with each function included in software, the information including changes to source files, changes to executable files, behavior resulting from changes, assessment of behavior, and developer identifier; and allowing a user to query for the automatically collected information and provide the results of the query in a graphical user interface.

A further embodiment of the invention provides a method of performing software certification. The method includes, during execution of software, automatically collecting information regarding every each execution path for a function and storing the collected information to a database, and allowing a user to query the database to retrieve information matching certification parameters.

Yet another embodiment of the invention provides a method of identifying a unique execution path. The method includes receiving, by a processing unit, real-time execution data, determining, by the processing unit, a unique execution path based on the real-time execution data without referencing information associated with a program image, and, when a unique execution path is determined, saving information to a database associated with the unique execution path. Determining the unique execution path can include determining if the real-time execution data for an executed instruction includes a BRANCH message and, when the real-time execution data includes a BRANCH message, save and export an identifier and an address of a previously-executed instruction.

Another embodiment of the invention provides a method of collecting execution data for software. The method includes receiving real-time trace data for a portion of the software, and storing the real-time trace data and information about conditions of the software at a start time associated with the real-time trace data. Storing information about the condition can include storing a representation of a function call stack and contents of memory locations associated with the real-time trace data.

A further embodiment of the invention provides a method of analyzing execution data for software. The method includes storing, by a processing unit, execution trace data for the software when the software is executed, storing, by the processing unit, source code for the software when the software is executed, storing, by the processing unit, a program image of the software when the software is executed, and replaying the execution of the software using the execution trace data, source code, and the program image. The method can also include indexing the execution trace data.

Yet another embodiment of the invention provides a method of identifying anomalies in software. The method includes executing a function included in the software along an execution path, wherein the function includes a predetermined number of valid execution paths, determining, by a processing unit, an identifier for the execution path, wherein the identifier uniquely identifies the execution path as compared to other execution paths for the function, comparing the identifier to a set of predetermined identifiers, the set including an identifier for each of valid execution path, and, when the identifier is different from each identifier in the set of predetermined identifiers, flagging the execution path as an anomaly.

Yet a further embodiment of the invention provides a method of collecting execution data for software. The method includes collecting real-time instruction-only trace data during execution of the software by a processing unit, decoding the real-time trace data to determine a flow of instructions during execution of the software, correlating the flow of instructions with data transfers occurring on an external memory bus or input/output bus of the processing unit, and storing the results of the correlation to a database. Correlating can include using an instruction set simulator to correlate the flow of instructions with the data transfers.

Other aspects of the invention will become apparent by consideration of the detailed description and accompanying drawings.

### BRIEF DESCRIPTION OF THE DRAWINGS

FIG. 1a illustrates an interface provided by a software debugger that indicates a current instruction, a past instruction, and upcoming paths.

FIG. 1b illustrates an interface provided by a software debugger that only indicates a current instruction.

FIG. 2 illustrates an interface provided by a software debugger that displays program variables part of a background image.

FIG. 3 schematically illustrates a real-time data acquisition and processing system.

FIG. 4 schematically illustrates another real-time data acquisition and processing system.

FIG. 5 schematically illustrates cascaded peer systems.

FIG. 6 schematically illustrates a computer system.

FIG. 7 schematically illustrates the computer system of FIG. 6 with cascade and steering functionality implemented on-chip.

FIG. 8 schematically illustrates using expansion slots as a high-capacity data highway for peer systems.

FIG. 9 schematically illustrates the configuration of FIG. 8 including a real-time trace data source.

FIG. 10 schematically illustrates a data block header.

FIG. 11 illustrates a graphical user interface illustrating unique behavioral identification data.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium and executed by a processing unit, such as a microprocessor). Accordingly, it should be noted that a plurality of hardware and software based devices, as well as a plurality of different structural components may be utilized to implement the invention.

As described above, embodiments of the invention use unique behavioral identification of software execution at the function level as an indexing method for a replayable database of software functions. For every variation in the way a software function is executed, a unique identification number is created for that behavior. This identifier is then compared with the contents of a data set, such as a database, to determine if a match is already present in the data set or if the identifier represents a unique behavior that has not been previously exhibited. If the behavior is new, the identifier and the replayable content of the software execution is added to the data set, otherwise the behavior is simply noted as a repeat of previously-observed behavior.

One use of embodiments of the invention is to facilitate the on-demand replay of the unique behavior event (and the events leading up to and following it) by a software developer, using a familiar software debugger-like environment. Replay of the event appears to the developer to be as though he or she painstakingly tracked-down the cause of each behavior using a conventional software debugger, and have finally identified the point that exhibits the incorrect behavior. However, as noted above, this tracking and identification this happens instantly, on-demand for every behavior exhibited by every function in the software application.

The developer can then assess the behavior and classify it as ‘correct’ or as something that needs modification to remove the unwanted behavior. This behavior assessment, along with key information such as time, date, and the developer's identification become a permanent part of the dataset for that function and application.

Accordingly, embodiments of the invention enable the review and assessment of every behavior of every function in an entire software application, enabling the software developer to no longer waste time on conventional software debugging, while simultaneously enabling the review, assessment, and detection of defects with subtle bugs or very low recurrence rates. This means that higher-quality software can be created with fewer residual defects, in a greatly reduced time span than with conventional tools. Thus, a software application can be confidently considered ‘ready for release’ when every behavior has been reviewed, corrected if needed, and approved for release by developers and QA testing staff.

### System and Method of Software Execution Identification by Object Construction Activity

In a software development environment the process of finding software defects (debugging) can take a considerable amount of time. The cause of this difficulty lies in the complexity of the application software debug debugged, and in the lack of visibility provided by existing debugging tools. On a modern processor, software can execute at rates exceeding a billion instructions per second, resulting in software functions being called millions of times. However the capacity available to export this information is usually limited to a much smaller fraction, which requires the software developer to specify the exact portion of execution debug information to export.

Ideally, this would be the portion of execution data around a software defect of interest, thus allowing the developer to better understand its cause and to implement a fix, but in reality the exact cause of a software defect is not immediately known, so the developer must pursue an iterative cycle of specifying areas of data to capture, getting the defect of interest to execute in software, capturing and examining the execution data, revising the specification of data to capture and repeating until the needed execution data is captured. This process can take hours or sometimes days to complete, resulting in the fixing of one software defect.

The types of defects that plague software programs can be classified into several broad categories. One of the largest categories is data errors, wherein the data objects that are the subject of the code execution are not correctly processed, even though the code that does this processing is executing correctly.

As an example, consider a software function for text-sentence formatting that 1) capitalizes the first letter of the sentence, and 2) converts any capital letters that are not the first letter of a word to lower-case. Such a function would produce correct results with sentences such as “jAne SMith is at the door”, but would produce incorrect results with “Jane McDonald is at the door”. Detecting this error is normally a manual process: the resulting sentences are human-inspected during development and test, and hopefully the error is noticed and a fix can be implemented.

Some embodiments of the invention automate the detection of such errors by creating a unique identifier based on the actions performed on the data object. In the above example, the action of correcting the first sentence's capitalizations of the first and second characters in the first word, and the second character in the second word would create a different identifier than the actions of the second sentence, which had a capitalization change of the third character of the second word. Note that embodiments of the invention are not limited to text strings. Rather, any object in a computer program can be similarly identified based on the actions taken during its creation and processing.

These embodiments of the invention have the benefit of making obvious any objects that were created or modified in ways that were different from other such objects from different execution periods, which can quickly highlight any anomalous objects. This can be of great assistance to a software developer attempting to determine if there is anything unusual about an object of interest, as compared to every other iteration of that object.

For example, embodiments of the invention include methods and systems for identifying software execution sequences by the actions used in object construction is disclosed. Accordingly, for every candidate object, the methods and systems:
1. Initialize an identification variable (ACTION_ID) with a constant value (e.g., 0) at the objects' instantiation, construction, or initialization.
2. At every WRITE operation to that variable or any portion thereof:
   (a) Sum into the ACTION_ID variable a unique value composed of a hash of one or more of the following:
      (i) The offset into the data object at which this write happens.
      (ii) The size of this write.
      (iii) The enumerated count of writes at which this write occurs.
      (iv) The identifier (address, thread ID, other) of the code that is performing this write.
3. Export the resulting ACTION_ID at appropriate places: when the object is used, when it is deconstructed, destroyed, or goes out of scope.

Embodiments of the invention are suitable for implementation in silicon (thereby creating a data-driven execution trace system), implementation in software (suitable for systems with limited real-time execution visibility), or implemented as a post-processor for existing real-time trace systems to identify unique execution sequences. Embodiments of the invention can be used by itself as a triggering mechanism of any data object activity, used with a local cache and comparator to detect new/unusual data object actions, or implemented with a database system to automatically create a full-spectrum database of all actions on every object.

Software Debugger with Execution Path Display

Development of software programs is commonly done using a software debugger, which is a software application that presents to the developer one or more program code sections of interest. During debugging, this application is used to represent the current status of execution in the area of interest: which line of software code is currently being executed, and the current state of system registers and memory locations. An interface is generally provided for the developer to assert manual control over the program execution, such as single-stepping the processor through program instructions, setting breakpoints, and a mechanism to run and halt the processor's execution of software code. This enables the software developer to halt the program execution at specific execution conditions, and to gather additional information to determine causes of incorrect behavior and implement a correction to the software.

This approach is typically taken when using a breakpoint debugger on a running target, wherein a breakpoint or other halt condition will stop execution of code on the target processor, thereby allowing the developer to examine the contents of processor registers or system resources. One disadvantage with debugging a running target is that it is not possible to know the upcoming execution path, and there is no reverse-step capability, so the developer must pay close attention while stepping down a blind path with an uncertain outcome.

Software debugging with a real-time trace debugger has the potential to avoid this upcoming-path uncertainty, but these tools generally operate with the same user interface as their non-trace counterparts. While many of these tools are able to step forward and backward to discover the upcoming and previous execution paths, these manual approaches can be tedious and time-consuming, and depend on the close attention of the user to remember the path taken through the software code.

Embodiments of the invention provide a superior visual representation of execution path to the software developer, using a familiar interface. These embodiments are suitable for both real-time trace debugging, wherein the complete, full-speed execution path of the software is already known in detail, and breakpoint debugging using a software simulator to find a most-likely matching path based on the contents of the processors registers and memory.

Furthermore, embodiments of the invention are suitable for including onscreen representations of program variables plotted temporally, wherein these variables are presented adjacent to the execution path point at which they are used or modified.

In particular, embodiments of the invention provide methods and systems for improving software debugging capabilities. The methods used can depend on if the mode of use is with a replay debugger for real-time trace data or with a breakpoint debugger in a non-replay environment or with a live target.

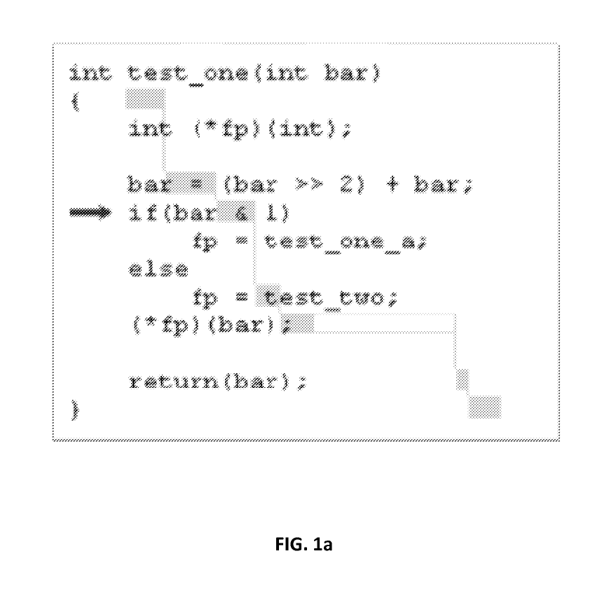

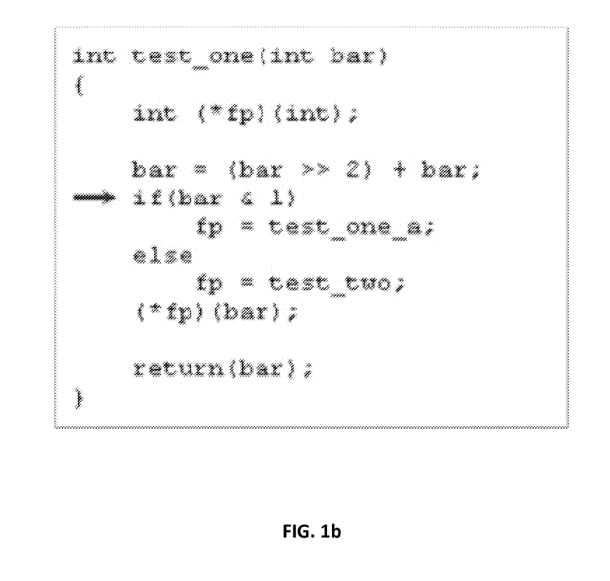

When used with a replay debugger with real-time trace data, the previous and upcoming trace data around a desired position is analyzed to determine which code has been executed, resulting in an exact representation of the execution path taken prior to the desired point, and the exact execution path after the desired point as illustrated in FIG. 1a. In particular, FIG. 1a illustrates a debugger with path display according to embodiments of present invention. As illustrated in FIG. 1a, the current instruction and the past and upcoming paths are clearly displayed. In contrast, FIG. 1b illustrates the ambiguity in execution path that is available with existing methods. In FIG. 1b, only the current instruction is indicated (i.e., by the arrow).

When used with a breakpoint debugger on a currently-running target processor, there is little immediately-usable information to determine the exact path that led up to the current point in execution, and to determine the path that will be taken following the current point. However, a most-likely execution path may be obtained by examining key register and memory values in-system, and using these values as inputs to an instruction set simulator (“ISS”) for the target processor, and by using these values for comparison with the possible outputs of simulation results.

To determine the path that had led up to the current point of execution within the current call stack level, the instructions preceding the current point are processed iteratively in an ISS, and the resulting key register and memory values are compared with current values read from the target. These results are used to find a ‘best fit’ path based on the probability that the preceding instructions had happened within any of the possible paths, resulting in a probability value for every instruction that precedes the current instruction, and an overall confidence level for every complete path possibility. The results of this path calculation are presented to the user, with options to display only the most-likely path leading to the current instruction, or to display multiple possible paths, using color, intensity, annotation, or similar to indicate probability.

To determine the execution path that is most likely to follow the current execution point, the ISS is again employed, using the values of key registers and memory locations read from the target to determine the execution path that is most likely to be taken following the current instruction. Note that this approach might not accurately predict the actual path; events such as interrupts and exceptions can cause changes in execution path in nondeterministic ways. The resulting paths and probabilities are then presented to the user with the same methods and options as used with the preceding—path calculation.

Note also that if the breakpoint debugger is single-stepped through the upcoming instructions, embodiments of the invention can re-run the simulations at each step to successively improve the confidence in the upcoming path. Additionally, the path history can optionally be calculated and stored at every halt, breakpoint, or other event that yields information which can be used to determine the executed path. This cumulative path history can then be presented to the used at their option, using distinctive colors, intensities, patterns, annotations or similar features to distinguish each path and its cumulative total of events.

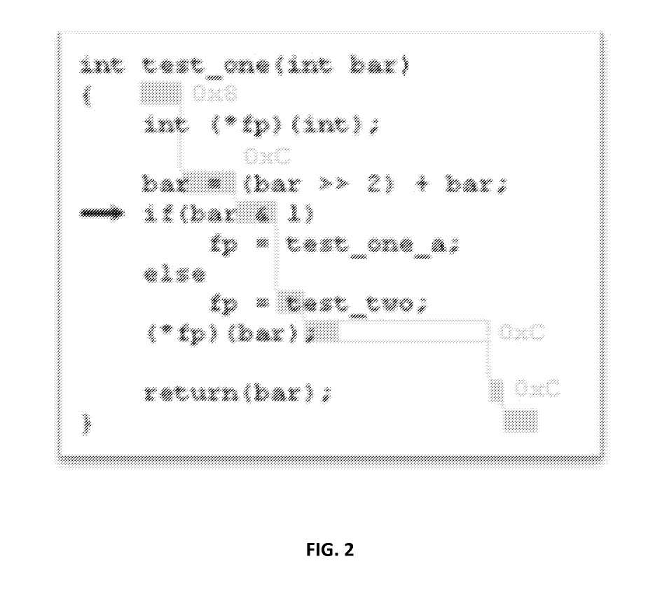

Embodiments of the invention are also suitable for displaying program variables in an intuitive manner as illustrated in FIG. 2. This is particularly helpful when displaying looping code segments, as the number of remaining loops to execute would be made clearly visible by the display of program variables. In particular, FIG. 2 illustrates displaying program variables as part of the background image. From this single image, the program's execution path, relative timing, value of a passed program variable, the modifications made to variables, and the value of the returned variable can be immediately determined.

### System and Method of Software Execution Trace Data Reduction

In a software development environment it is useful to have abundant visibility into the target software program flow and data values during full speed execution. This makes it possible to observe and correct any functional defects, and to better understand the program operation and make changes to optimize the execution. A real-time trace system may be employed to achieve maximum visibility, exporting a continuous stream of values representing the program flow and data values, but this often requires substantial resources with existing implementations, as the data export capacity requirements can range into the gigabytes per second range during full-speed execution. When multiple processor cores are implemented on the same device, this capacity problem is exacerbated.

Existing real-time trace systems have been implemented with a pessimistic view of the recipient of their data, having been designed to be usable with collection buffers as small as a few hundred bytes. These systems are required to export enough information in a short period of time to make a complete reconstruction of execution using external tools. Many of these existing real-time trace systems were originally designed in an era when multi-million transistor devices were a rarity, so they were designed to be implemented using a small amount of on-chip resources and did not pursue more efficient trace export schemes that require additional resources.

As an example, a software sequence that increments a variable in memory would first READ the value from memory (resulting in a real time trace export of the address of the variable and its present value), increment that value by one, then WRITE the variable back to memory (resulting in another real time trace export of the address of the variable and its new value). Clearly, one of the two above data exports is unnecessary, because the address is already known and the data value can be easily calculated.

Processor transistor counts and speeds have continued their explosive growth, while overall software application size and complexity have similarly grown. To offset the additional burden of exporting a meaningful amount of real-time trace data from these faster processors, real time trace systems based on existing designs have chosen to reduce the amount of information being exported, instead of implementing improvements in overall efficiency. The most common approach is to eliminate the export of the data address and data value entirely from the real-time trace export, leaving just the instruction trace to be exported. The result is that software developers of larger and more complicated applications running on newer devices have reduced visibility into the software's execution, compared with older designs that exported more complete information. This reduction in software execution visibility is a step in the wrong direction; to successfully develop ever-larger and more complex applications, software developers need an increase in visibility, not a reduction.

Embodiments of the invention take advantage of the reduced cost of on-chip resources, and the processing performance improvements in external equipment to implement a real-time trace export system with greater efficiency and more complete visibility into the executing software. This greater efficiency is achieved by suppressing export of data values that can be accurately recreated by external simulation of the on-chip processor actions using previously-exported information and the known program code as a starting point.

Using the above example of a simple increment of a value in memory, the embodiments of the invention could suppress the trace export of the READ operation (since the pre-increment value of the variable could easily be determined by examining the trace output of the subsequent WRITE operation), or could suppress the trace export of the WRITE operation (since the data value could easily be determined by examining the trace data from the preceding READ operation), or could even suppress the trace export of both the READ and WRITE operations, if the external tool had already collected the last-known value of that variable from a previous operation. The result is that more information can be made to software developers to rapidly find and fix every defect, and to enable unprecedented levels of visibility, analysis, and replay of everything that happens in the otherwise hidden on-chip world of software.

Accordingly, embodiments of the invention provide methods and systems for reducing the amount of execution trace data based on its potential for external reconstruction is presented. These embodiments offer flexibility in adapting to a variety of systems with varying levels of external data visibility, and can be initialized to take a pessimistic view of external reconstruction capabilities either temporarily (such as when a debugger is first attached to the target system) or permanently (to support cases of debuggers with limited reconstruction capabilities).

The method can use companion bit for data operands to indicate that the value can be externally reconstructed—a ‘RECONS’ bit. This additional bit is effectively appended to the processor's architecture to the degree desired or allowed by the processor design constraints. As a preferred embodiment, this additional bit would be available for all processor registers and internal data memory locations.

In operation, the RECONS bit would be set for data operands that can be externally reconstructed, cleared if the data operand should be exported to real-time trace, and would inherit the logical AND of the RECONS bits of the elements used in any arithmetic or logic operations in the processor. For example, constants used in an application (such as clearing the contents of registers or memory by writing a ‘0’ value) would qualify as externally reconstructable. Reading the value of a memory location that had previously been written and exported to real-time trace would also be classified as externally reconstructable and would not need to be re-exported to real-time trace. During execution, the logical AND of the RECONS bits are used to determine if the resulting operand needs to be exported to real time trace. Using the above example, if using a value read from memory with a set RECONS bit as one operand, an arithmetic or logic operation with a constant value (which also has a set RECONS bit) would result in the RECONS bit remaining set for the result. However, if the operation was with an operand with a cleared RECONS bit, then the result would also have a cleared RECONS bit and need to be exported to real time trace.

Implementation and setting of the RECONS bit in different system areas would be configurable and dictated by the possibility of being externally computed. Examples of system components whose internal values could be externally reconstructed include: I/O peripherals whose data ports are also monitored by the reconstruction equipment, external memory with address, data, and control signals accessible to the reconstruction equipment, and deterministic on-chip resources such as free-running counters operating at known intervals. These would be candidates for having a set RECONS bit during execution while connected to a real time trace reconstruction system. System components that are non-deterministic in their resulting data values are not eligible for having a set RECONS bit.

To configure the RECONS bit settings for a system with a variety of components that may or may not be externally monitored, embodiments of the invention include configuration registers to selectively enable RECONS bit settings for each system component, thereby reducing the amount of trace data to export in proportion to the amount that can be derived from other sources. For example, in a target processor system that contains both on-chip RAM and off-chip RAM, if the external trace reconstruction system were to have access to capturing the contents of the off-chip RAM's address, data, and control signal—thereby enabling complete visibility into every READ and WRITE operation in this external memory—then the RECONS bit setting should be enabled for every read or write operation from this memory region.

Additionally, on attachment or enabling of the trace reconstruction system, the RECONS bits in system memory could optionally be reset to 0, thereby taking a pessimistic view of the external reconstructor and forcing the export of the first read or write values from each location, at which point the RECONS bit would be set for that location.

With the abundance of transistors and logic available through continued process shrinks, implementing embodiments of the invention in silicon represents a small portion of the device. Embodiments of the invention are also appropriate for a software-only implementation into systems without a hardware real-time trace system, and to be used as a basis for reducing the data volume from systems that already have complete real-time trace ports, as it enables 100% (or approximately 100%) reconstruction of all data values through the assistance of an instruction set simulator

### Cascaded Real-Time Processing and Storage System

Computer systems used for real-time processing of data are frequently large and expensive, owing to the need to produce maximum data processing capacity within a single system. The requirement for processing within a single system stems from the relatively high capacities of the in-system data connections vs. the relatively low capacities of common inter-system data connections such as Ethernet—real-time processing performance will be bottlenecked by these inter-system connections, limiting overall real-time performance. Example application areas include graphics rendering, signal processing, network traffic inspection, data analysis, and others.

To improve on real-time capacity, chip and computer makers have focused on improvements within the chip or computer itself: multiple processing cores, high-capacity on-chip interconnects, and high-capacity interconnects to in-system components such as memory, mass storage, and expansion slots such as PCI Express (“PCIe”). Improvements to intra-system connectivity has been gradual and focused on network-compatible standards such as Ethernet. Gigabit Ethernet is now commonly available for system interconnection, but has a maximum capacity of only 125 million bytes per second (“MB/s”). This is but a small fraction of the intra-system capabilities of current computer systems which are typically measured in the tens of billions of bytes per second.

Solutions to address the capacity limitations of inter-system communications have been devised, such as Infiniband, RapidIO, and multi-gigabit Ethernet. These solutions will generally add significant cost to the overall system; requiring additional chips, add-in assemblies, custom cabling solutions, and layered software interfaces to the operating environment. In short, Intra-system data transfer capacity does not translate easily to intra-system capacity; significant expense is required to bridge these computing islands at data capacities that approach the in-system capacity.

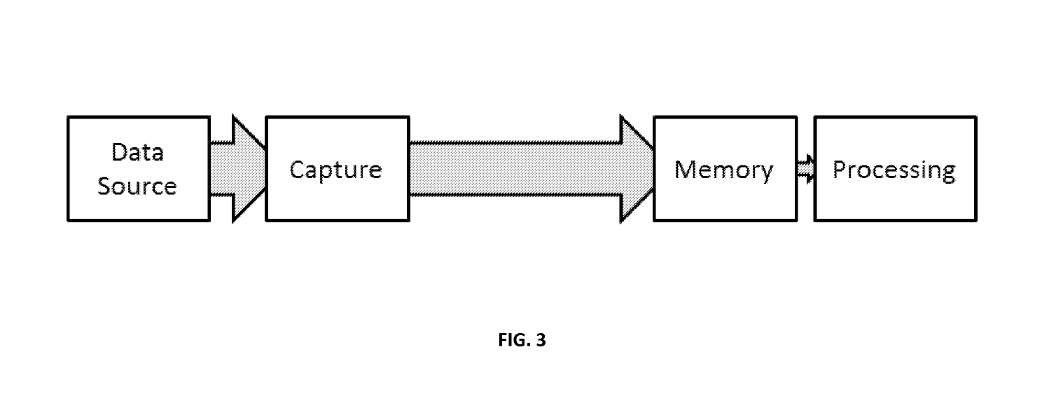

Consider a typical real-time data acquisition and processing system (see FIG. 3). The high-capacity data path is a point-to-point solution: from source to memory. Data is routed to memory until a triggering event (such as a pre-defined data sequence or the memory getting filled) causes collection to discontinue, letting the data processing system work on the collected data. Data processing often occurs at a much slower rate than data collection, thus requiring this intermittent mode of operation. This configuration and mode of operation is typical for many types of data acquisition and processing: test equipment, such as logic analyzers, oscilloscopes, protocol analyzers, network analyzers, medical diagnostic imagers and analyzers, scientific data processing, and real-time trace data analysis used in software development.

Substantial improvement could be achieved in these real-time processing applications at minimal expense using embodiments of the invention: a small modification to the in-system data transport facilities. By implementing an optional steering mechanism to these in-system data transport channels, data could be routed between systems at high capacity, while avoiding the substantial cost and system overhead associated with contemporary solutions.

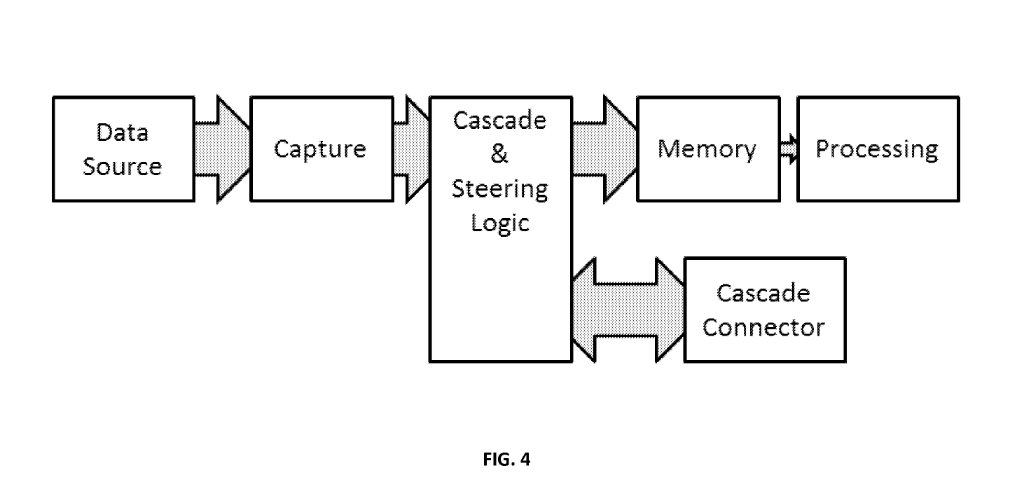

Accordingly, embodiments of the invention add some lightweight steering logic and a complementary input-output port connected to the high capacity in-system data path. For example, using the above example of a typical data acquisition and processing system, one embodiment of the invention is illustrated in FIG. 4.

As illustrated in FIG. 4, the data to be processed is instantaneously exported to the added cascade port, with the inclusion of slicing/synchronization information created by the steering logic. This information instructs the downstream systems as to which portion of the cascaded data should be routed for capture within their internal memory for processing, and which portion should be passed-along to downstream peers.

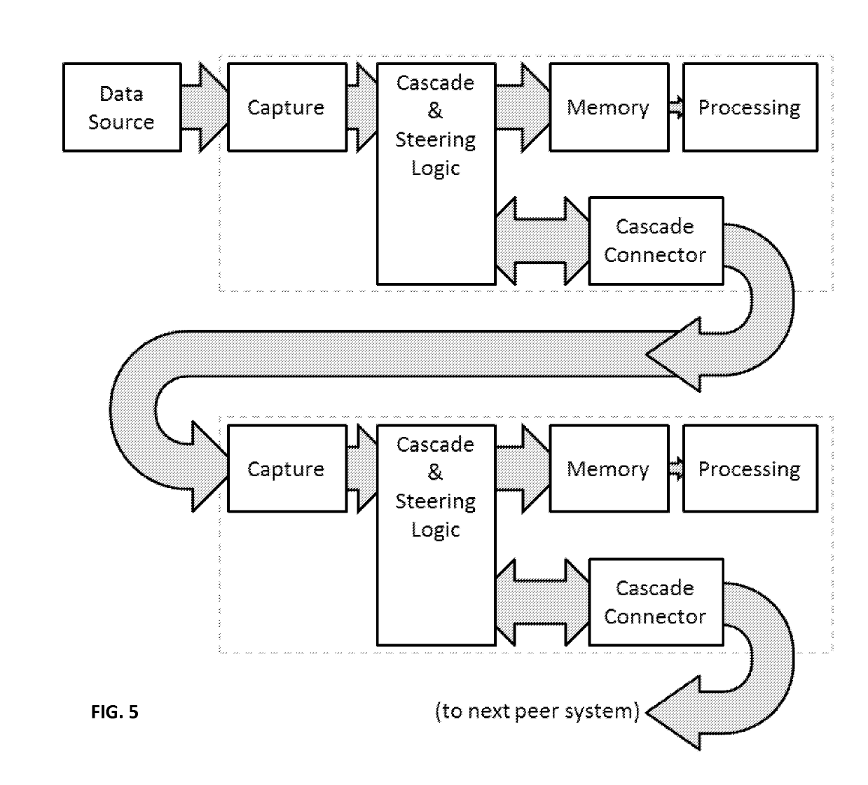

Using this approach, equivalent peer systems can be cascaded to achieve parity of processing and storage capacity to system data capacity, as illustrated in FIG. 5.

Each added peer system contributes a fixed amount of real-time processing and storage capacity; these are effectively summed to create aggregate performance that meets or exceeds the real-time requirements of the intended application.

For example, in a continuous processing application for real-time trace (“RTT”) data from a software application running at full speed, let the example RTT data be produced at a rate of 1200 Mbytes per second, and let the processing capacity of an individual system be only 500 Mbytes per second—far short of the requirement. This would normally require intermittent collection and processing, resulting in reduced visibility and the greater likelihood of failing to capture important event in the RTT data.

Using embodiments of the invention allow a cascaded configuration of three or more equivalent peer systems, resulting in an aggregate real-time processing performance of 1500 Mbytes per second, which can provide for 100% continuous processing of the RTT data. Each peer system in the chain will collect and process approximately ⅓ of the data, sliced into meaningful chunks that fit within the capacity of a single system. This results in the capture and processing of every event exhibited by the RTT data.

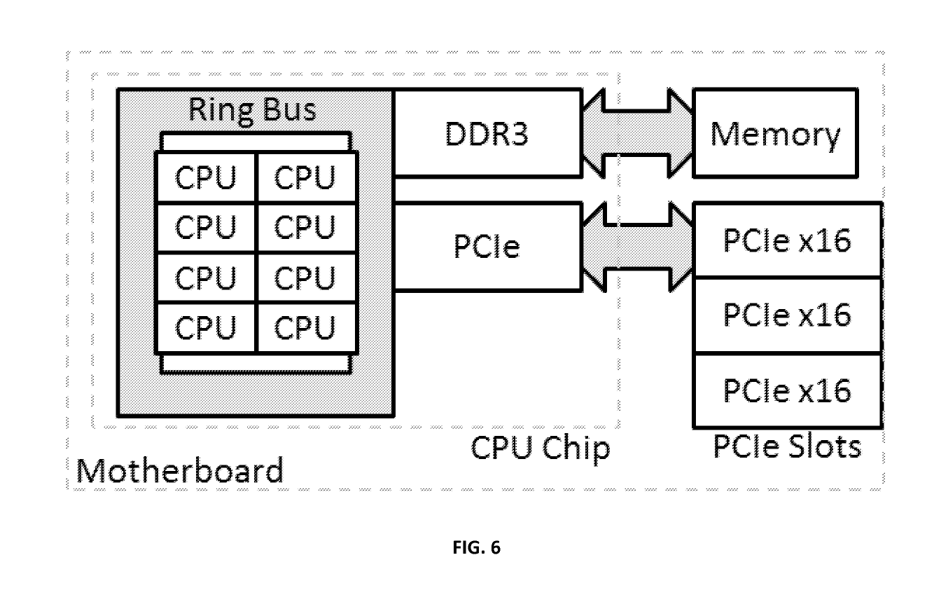

As a second example, embodiments of the invention can be implemented on-chip in a conventional computer system that includes expansion slots such as PCI Express (“PCIe”). An illustration of such a typical computer system is provided in FIG. 6.

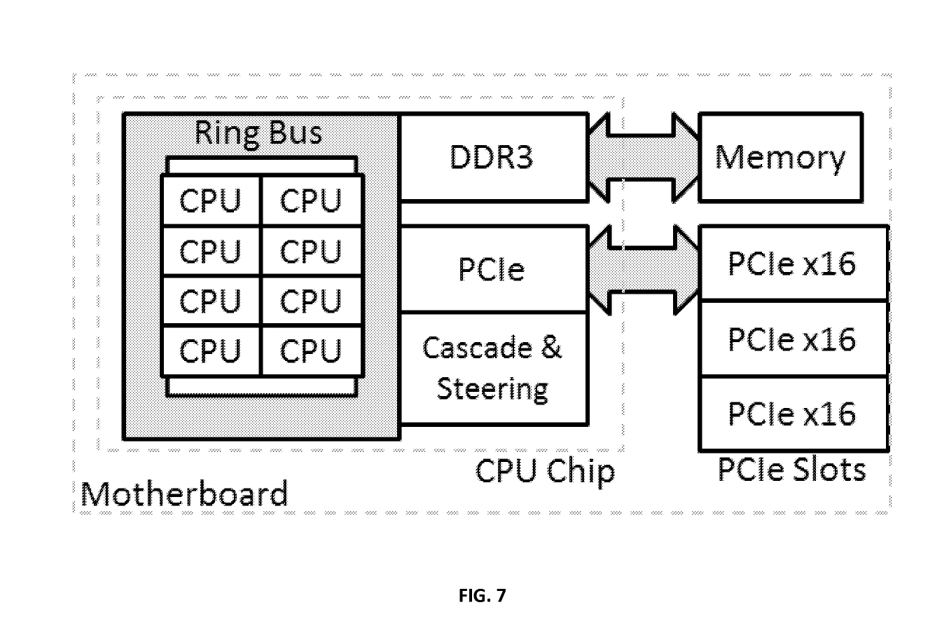

The second example embodies the invention in a typical computer system as shown in FIG. 7.

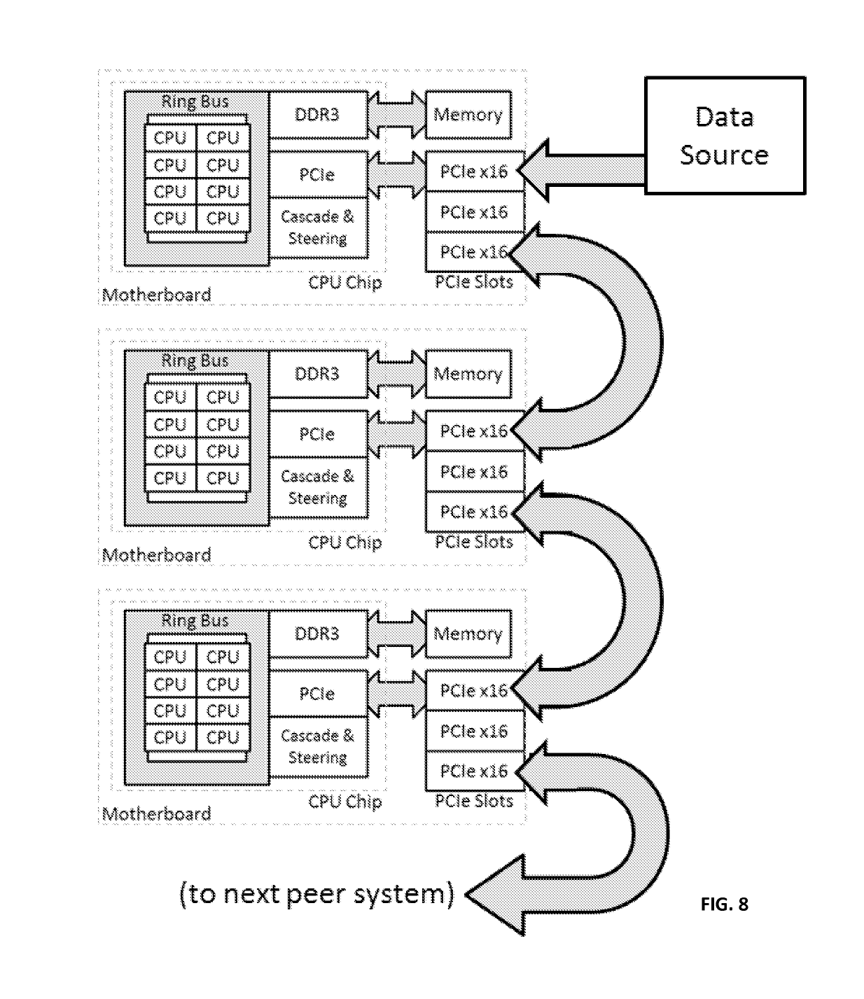

Under normal operating conditions, the PCIe slots appear and function as would a normal PCIe slot, offering data transfer capacity in the range of 8,000 to 15,000 Mbytes per second and beyond. Embodiments of the invention enable these expansion slots to be individually configured as a high-capacity data highway for peer systems, using only a low-cost cabling arrangement to link the PCIe slots of peer systems as illustrated in FIG. 8.

In this embodiment, the PCIe protocol for signaling and identification may be reduced or replaced with a lightweight protocol; the objective is to create a high-capacity interconnect using the physical interface circuitry that is already in-place. Strict PCIe compatibility may be optional. Given the above implementation on a modern PC motherboard with PCIe version 3, an interconnect using 16-lane PCIe slots would yield a bidirectional data path with a capacity of (985 Mbytes per second×16 lanes)=15,760 Mbytes per second in both upstream and downstream directions.

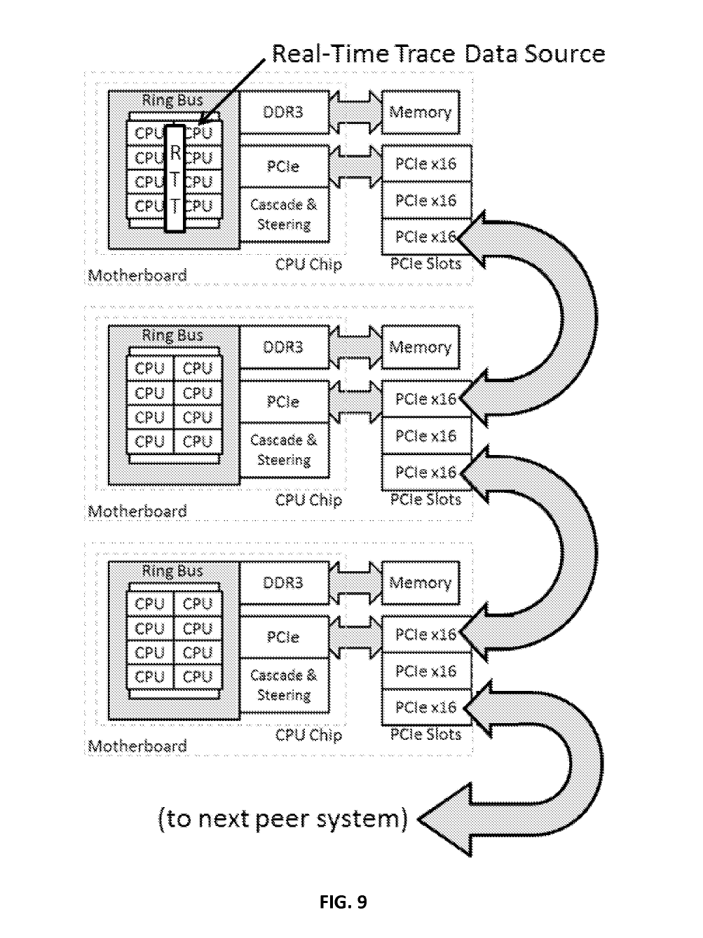

Using the earlier example of the processing of RTT data yields some if this data is generated within the CPU chip itself. Consider the following illustration in FIG. 9.

The RTT data from a CPU is notorious for creating extraordinary amounts of data during full-speed software execution; this normally presents a problem for the CPU maker. While the data is valuable, the sheer volume of this data typically requires the use of dedicated processor package pins strictly for the use of RTT data collection, or multi-use package pins that are available for RTT data collection but are usually assigned to other uses that might not be compatible with RTT data collection.

Additionally, the high volume of data can quickly overrun the local processing and memory capacity of a standalone system. These limitations compel the CPU maker to either eliminate the export of RTT data, or to reduce it to simplified forms such as branch history trace or instruction trace without data access trace included. These limitations reduce the visibility into what's really happening with the executing software.

However, in the above system example there is no need for the CPU maker to reduce the quality or quantity of the exported RTT data because of the massive inter-system data transfer capacity afforded by embodiments of the invention. Furthermore, a continuous RTT processing and storage system could be configured for even the most complex software systems running advanced operating systems, low-level device drivers, shred libraries and DLL's, and multiple high-performance applications—all running simultaneously on multiple processing cores within the CPU package. In some situations, configuring such a system would include only an embodiment of the present invention, implemented in commodity CPU's on conventional motherboards, and low-cost cabling to connect the PCIe slots of peer systems together.

The steering logic used in embodiments of the invention can accommodate not only time- or length-slicing the data, but also includes simple routing methods to enable data to be sent and routed to specific nodes. This enables a range of peer-network topologies to be constructed, such as chain, tree, star, mesh, etc., as well as limited implementations of intelligent routing: avoiding congested or malfunctioning links, reducing the number of ‘hops’ required to reach the destination, etc.

The implementation of the steering logic can include logic for determining the local destination route. By examining and measuring the data and routing information, and comparing that with locally-stored routing information, the data will be steered to one or more destinations: local memory, or to one or more PCIe slots that are configured for embodiments of the invention.

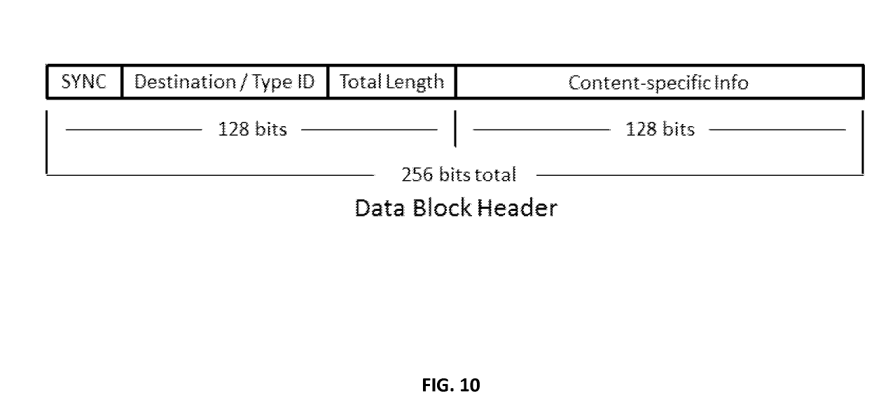

For example, in some embodiments, a small amount of the total capacity of the system interconnect for the insertion of a signaling and routing header is used as illustrated in FIG. 10.

The fields of the data block header can include:
(i) SYNC: a distinctive pattern of bits used to establish and maintain synchronization with the data block headers in systems that lack other methods of enforcing data alignment. This is a pattern of data that, when combined with the ‘Total Length’ field to find the location of the next Data Block header (and its SYNC field), is unlikely to be repeated consistently anywhere else but with correct alignment to the data block headers.
(ii) Destination/Type ID: This is a multi-use field to indicate the type of data type, routing type, and destination of the data block. For example, this field might contain:
   (a) A simple block counter to route successive blocks to sequential destinations, such as: 0=data goes to system 0, 1=data goes to system 1, 2= . . . etc.
   (b) A data type identifier, alerting the destination processor of that type of data to receive the block.
   (c) An absolute address for the destination system, to be used for simple compare-match reception, but also supporting limited routing capabilities in nonlinear system-interconnect topologies such as trees, grids, etc.
   (d) An indication that the data block has already been received by a destination and is therefore available for use with other data.
(iii) Total Length: This field describes the total length of the data block, including the header.
(iv) Content-specific info: to be used by the receiving system. This field may be used for data payload checksums, indexing, etc.

Accordingly, the steering logic establishes synchronization with the data block headers and performs a logical check on the Destination/Type ID field to determine the destination of the entire data block:
(i) To that systems' local memory for processing. In this event, the field would be marked as ‘available’ before sending to any downstream destinations, and the data payload sent to these locations may be zeroed.
(ii) To an appropriate cascade output port, to be received by an awaiting downstream system.

The steering logic can use the Total Length field to determine the quantity of data to send to either destination, and to maintain synchronization with the data blocks. Data blocks can be of fixed or variable size.

### Software Behavioral Review System

Developers of computer software face a daunting challenge with conventional development tools and procedures. The conventional methods for debugging software and gaining an intimate understanding of how the software actually works involve a great deal of trial and error and require the developer to mentally simulate the software to understand how it works and more importantly, how it can fail.

One problem is that software defects, also known as ‘bugs’ are usually detected by their external symptoms. During software development, an engineer might notice from external symptoms that a software application is doing something incorrectly. This starts the process of debugging. The developer will then use their familiarity with the software to hypothesize what portion of the software might be the cause of the incorrect behavior. The go-to tool at this point is a Software Debugger, a tool which allows the developer to set a ‘trap’ on a specific condition that is suspected of causing the incorrect behavior. This is known as a breakpoint or a trigger condition.

The program is then run, often repeatedly until the incorrect behavior is exhibited or the debugger's capture condition is matched and a small amount of execution data is obtained. Frequently, the breakpoint will be hit and data captured, but the conditions were not exactly correct to capture the cause of the error. The developer will then modify the conditions to capture data and try again, proceeding in an iterative manner, learning more about what is not causing the error until the correct conditions for capturing the incorrect behavior at the moment it happens can be set up in the debugger.

This is a process that can take a few minutes or several hours for software defects that repeatedly exhibit the incorrect behavior, however some types of software bugs are transient in nature, and only happen under circumstances that are difficult to repeat. These types of defects can be extraordinarily difficult to resolve, and can take days or weeks of effort using highly skilled and expensive resources.

In a software development team environment, conventional software tools force developers to toil in isolation; incorrect behavior that is revealed by one developer is not automatically shared amongst other developers. The process of quality assurance (“QA”) and/or quality control (“QC”) testing and bug-reporting is similarly a time-consuming process; a bug has little chance of being fixed if it cannot be succinctly described in a series of ‘steps to reproduce this bug’ that reliably cause the bug to happen.

A bigger underlying problem with conventional methods of software debugging is that software developers can only fix the bugs they know about. Bugs with subtle symptoms or low recurrence rates are very likely to pass undetected during development and be shipped with the application at product release.

Furthermore, this fundamental lack of visibility causes much difficulty in gaining an understanding of how a software function or application actually works. Software developers are typically expected to take from 3 to 6 months to learn enough details about an unfamiliar software program to become proficient, and even longer to be considered experts.

Accordingly, embodiments of the invention use a unique behavioral identification of software execution at the function level as an indexing method for a replayable database of software functions. For every variation in the way a software function is executed a unique identification number is created for that behavior. This identifier is then compared with the contents of a data set such as a database to determine if a match is already present in the data set or if this represents a unique behavior that has not been previously exhibited. If the behavior is new, the identifier and the replayable content of the software execution is added to the data set, otherwise the behavior is simply noted as a repeat of previously-observed behavior.

Embodiments of the invention can be used to facilitate the on-demand replay of the unique behavior event (and the events leading up to and following it) by a software developer, using a familiar software debugger-like environment. Replay of the event should appear to the developer to be as though they had painstakingly tracked-down the cause of each behavior using a conventional software debugger, and have finally reached the point that exhibits the incorrect behavior—but this happens instantly, on-demand for every behavior exhibited by every function in the software application.

The developer can then assess the behavior and classify it as ‘correct’ or as something that needs modification in order to remove the unwanted behavior. This behavior assessment, along with key information such as time, date, and the developer's identification become a permanent part of the dataset for that function and application.

Accordingly, embodiments of the invention enable the review and assessment of every behavior of every function in an entire software application, enabling the software developer to no longer need to waste any time on conventional software debugging, while simultaneously enabling the review, assessment and detection of defects with subtle bugs or very low recurrence rates. This means that higher-quality software can be created with fewer residual defects, in a greatly reduced time span than with conventional tools.

A software application can then be confidently considered ‘ready for release’ when every behavior has been reviewed, corrected if needed, and approved for release by developers and quality assurance (“QA”) testing staff.

For example, some embodiments of the invention include:

(1) logic for uniquely identifying software behavioral sequences. This can be accomplished by a plurality of methods, including but not limited to: timing measurements, execution addresses, examining the actions performed on data objects, detailed assessment of real-time trace data, etc., either alone or in combinations.

(2) logic for capturing execution data to facilitate on-demand replay of the behavior. This can be accomplished by a plurality of methods, including but not limited to: wholesale capture of real-time trace data, capturing key program variables, simulation primitives, branch history, execution addresses, etc.

(3) logic for replaying the captured execution data, preferably in a conventional software debugger-like facility, as well as in other analysis and visualization resources. This can be accomplished by a plurality of methods, including but not limited to: a replay debugger, a computer simulator, an equivalent target, etc.

(4) logic for assigning assessments to the individual behaviors, to include a quality and functionality assessment, developer notes, etc.

(5) A dataset or database to facilitate the storage and recall of the behavioral identifiers, execution data, assessments, notes, and other meaningful data. This can be accomplished by a plurality of methods, including but not limited to: databases, disk file systems, in-memory representation, offsite storage, etc.

Accordingly, embodiments of the invention can solve one of the biggest problems in software development: rampant defects and difficulty in gaining understanding of the actual behaviors of a software function or program.

In addition, the database contains a permanently-replayable record of everything the software has done. This means that even without ever collecting any additional data, this system is a valuable learning resource for software developers, and could be suitable for (for example) distribution with a software package (such as an operating system or middleware) as a training aid to enable developers to rapidly gain expertise in the software package. Also, the data is self-assembling; no additional effort is required to create the abundance of information about how the software actually works. Accordingly, embodiments of the invention recognize the ‘how-it-works’ knowledge of software execution as a tangible business asset, and can be archived, protected, sold, licensed, etc. Previously, this knowledge was exclusively within the minds of experienced developers, and could not be easily transferred to others.

### Software Project Management System

Developers of computer software face a daunting challenge with conventional development tools and procedures. The conventional methods for debugging software and gaining an intimate understanding of how the software actually works involve a great deal of trial and error and require the developer to mentally simulate the software to understand how it works and more importantly, how it can fail.

One problem is that software defects, also known as ‘bugs’ are usually detected by their external symptoms. During software development, an engineer might notice from external symptoms that a software application is doing something incorrectly. This starts the process of debugging. The developer will then use their familiarity with the software to hypothesize what portion of the software might be the cause of the incorrect behavior. The go-to tool at this point is a Software Debugger, a tool which allows the developer to set a ‘trap’ on a specific condition that is suspected of causing the incorrect behavior. This is known as a breakpoint or a trigger condition.

The program is then run, often repeatedly until the incorrect behavior is exhibited or the debugger's capture condition is matched and a small amount of execution data is obtained. Frequently, the breakpoint will be hit and data captured, but the conditions were not exactly correct to capture the cause of the error. The developer will then modify the conditions to capture data and try again, proceeding in an iterative manner, learning more about what is not causing the error until the correct conditions for capturing the incorrect behavior at the moment it happens can be set up in the debugger.

This is a process that can take a few minutes or several hours for software defects that repeatedly exhibit the incorrect behavior, however some types of software bugs are transient in nature, and only happen under circumstances that are difficult to repeat. These types of defects can be extraordinarily difficult to resolve, and can take days or weeks of effort using highly skilled and expensive resources.

In a software development team environment, conventional software tools force developers to toil in isolation; incorrect behavior that is revealed by one developer is not automatically shared amongst other developers. The process of quality assurance (“QA”) and/or quality control (“QC”) testing and bug-reporting is similarly a time-consuming process; a bug has little chance of being fixed if it cannot be succinctly described in a series of ‘steps to reproduce this bug’ that reliably cause the bug to happen.

A bigger underlying problem with conventional methods of software debugging is that software developers can only fix the bugs they know about. Bugs with subtle symptoms or low recurrence rates are very likely to pass undetected during development and be shipped with the application at product release.

Furthermore, this fundamental lack of visibility causes much difficulty in gaining an understanding of how a software function or application actually works. Software developers are typically expected to take from 3 to 6 months to learn enough details about an unfamiliar software program to become proficient, and even longer to be considered experts.

Conventional software development tools also impose a number of significant problems for software project management. They do not save or share information, they do not perform 100% evaluation of every executed software function, and they provide no means to assess project completion status or development trouble spots. All of these functions that relate to software project management are presently performed via manual processes or with specialized tools that require additional effort to use and maintain accuracy.

Despite the fact that software developers are commonly using development tools on computer systems that have abundant processing power, mass storage, and network connectivity, software development project managers are still forced by the shortcomings of conventional development tools to the time-consuming and inaccurate manual methods of gathering information for software project management. This often leads to unpleasant surprises such as schedule delays, the need to hurriedly omit or curtail features in new software programs, and missing the additional revenues available to a fast and predictable time-to-market.

Accordingly, embodiments of the invention use a unique behavioral identification of software execution at the function level as an indexing method for a replayable database of software functions. For every variation in the way a software function is executed a unique identification number is created for that behavior. This identifier is then compared with the contents of a data set such as a database to determine if a match is already present in the data set or if this represents a unique behavior that has not been previously exhibited. If the behavior is new, the identifier and the replayable content of the software execution is added to the data set, otherwise the behavior is simply noted as a repeat of previously-observed behavior.

In some embodiments, the behavior review information contained in the dataset can include details of program name, function name, behavior ID, assessment, ID of user making the assessment, and developer notes—for every function in a software project. Embodiments of the invention collect that data for analysis and display.

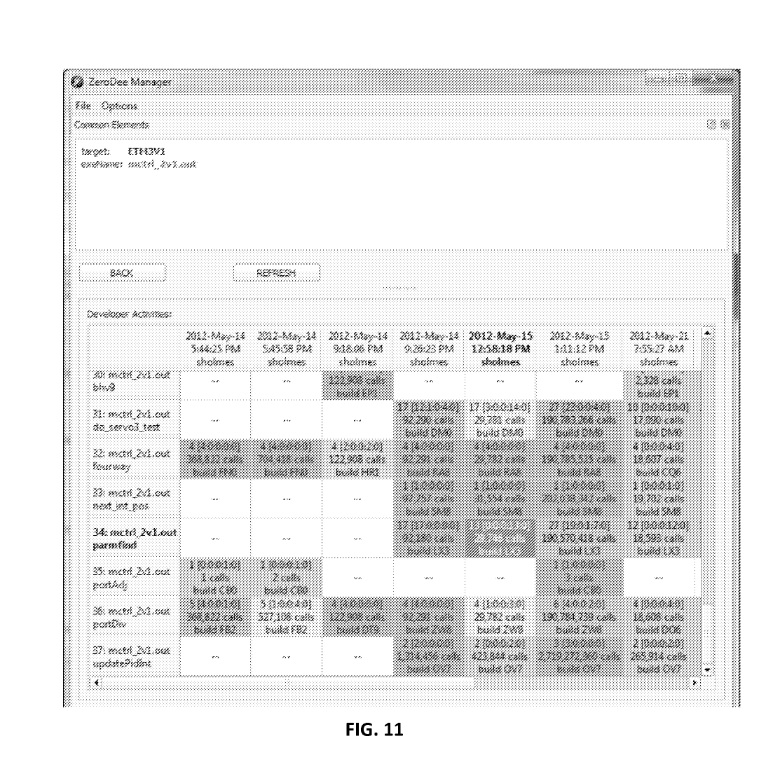

For project management use, one presentation of this data is chronologically (as illustrated in FIG. 11), arranged in tiers by project, function, behavior. Each chronological point in the display shows the status of the function and behavior, from new/unreviewed to approved, with indications of when the source file or build options for the function have been modified and by whom. This enables project managers to quickly identify overall project status, hot-spots in activity, trouble spots that are not making progress, and determine with a much greater degree of accuracy the completion date of a software project.

### Developer Assessment System

Developers of computer software face a daunting challenge with conventional development tools and procedures. The conventional methods for debugging software and gaining an intimate understanding of how the software actually works involve a great deal of trial and error and require the developer to mentally simulate the software to understand how it works and more importantly, how it can fail.

One problem is that software defects, also known as ‘bugs’ are usually detected by their external symptoms. During software development, an engineer might notice from external symptoms that a software application is doing something incorrectly. This starts the process of debugging. The developer will then use their familiarity with the software to hypothesize what portion of the software might be the cause of the incorrect behavior. The go-to tool at this point is a Software Debugger, a tool which allows the developer to set a ‘trap’ on a specific condition that is suspected of causing the incorrect behavior. This is known as a breakpoint or a trigger condition.

The program is then run, often repeatedly until the incorrect behavior is exhibited or the debugger's capture condition is matched and a small amount of execution data is obtained. Frequently, the breakpoint will be hit and data captured, but the conditions were not exactly correct to capture the cause of the error. The developer will then modify the conditions to capture data and try again, proceeding in an iterative manner, learning more about what is not causing the error until the correct conditions for capturing the incorrect behavior at the moment it happens can be set up in the debugger.

This is a process that can take a few minutes or several hours for software defects that repeatedly exhibit the incorrect behavior, however some types of software bugs are transient in nature, and only happen under circumstances that are difficult to repeat. These types of defects can be extraordinarily difficult to resolve, and can take days or weeks of effort using highly skilled and expensive resources.

In a software development team environment, conventional software tools force developers to toil in isolation; incorrect behavior that is revealed by one developer is not automatically shared amongst other developers. The process of quality assurance (“QA”) and/or quality control (“QC”) testing and bug-reporting is similarly a time-consuming process; a bug has little chance of being fixed if it cannot be succinctly described in a series of ‘steps to reproduce this bug’ that reliably cause the bug to happen.

A bigger underlying problem with conventional methods of software debugging is that software developers can only fix the bugs they know about. Bugs with subtle symptoms or low recurrence rates are very likely to pass undetected during development and be shipped with the application at product release.

Furthermore, this fundamental lack of visibility causes much difficulty in gaining an understanding of how a software function or application actually works. Software developers are typically expected to take from 3 to 6 months to learn enough details about an unfamiliar software program to become proficient, and even longer to be considered experts.

Conventional software development tools also impose a number of significant problems for software team management. They do not save or share information, they do not perform 100% evaluation of every executed software function, and they provide no means to assess developer activities or effectiveness. All of the functions that relate to software team management are presently performed via manual processes and reporting methods, and are prone to inaccuracies and reviewer bias.

For example, consider two different hypothetical software developers: one is constantly writing code, working long hours debugging and committing many code changes in a flurry of activity. The other rarely works late, will commit only a few changes to the software, and is often seen sketching on paper or just staring into space. Which developer is more effective? Is the first developer extremely productive or a loose cannon? Is the second developer experienced and methodical or lazy? Conventional development tools offer little in the way of providing objective data by which to assess their performance.

Despite the fact that software developers are commonly using development tools on computer systems that have abundant processing power, mass storage, and network connectivity, software team managers are still forced by the shortcomings of conventional development tools to the time-consuming and inaccurate manual methods of gathering management information to assess developer performance, effectiveness and overall value.

Accordingly, embodiments of the invention use a unique behavioral identification of software execution at the function level as an indexing method for a replayable database of software functions. For every variation in the way a software function is executed a unique identification number is created for that behavior. This identifier is then compared with the contents of a data set such as a database to determine if a match is already present in the data set or if this represents a unique behavior that has not been previously exhibited. If the behavior is new, the identifier and the replayable content of the software execution is added to the data set, otherwise the behavior is simply noted as a repeat of previously-observed behavior.

The dataset contains the needed information to assess the behavioral and performance characteristics of every user of the system, to include information about: changes to source files, resulting changes to executable program, resulting behaviors from these changes, and the assessment of these behaviors—as well as the time, date, user ID, and location of the person creating this information, and the times and dates of all other activities with the system including log in/out, replay of files, and the location and time of any newly revealed behaviors in the target software.

Accordingly, embodiments of the invention can leverage that data to create a real-time fact-based assessment of developer performance and work habits. For example, embodiments of the invention can analyze the changes made to the software source files (which source files, how big are the changes, how many changes, what time and date), and the resulting changes to the executable program binary image (how many changes, which software functions and behaviors are affected, what time and date were these made), and the resulting run-time behaviors of the software itself including the time, date, and locations where these behaviors have appeared. The assessments made by developers on these resulting functional behaviors, including the time, date, location, and user name can also be used and analyzed. Analysis of this data reveals the work habits and proficiency at writing new software, software debugging, thoroughness of testing and responsiveness to unexpected outcomes of every monitored software developer.

For example, using the above example of the two different developers, the analysis performed by embodiments of the invention could be used to identify that the first developer is somewhat undisciplined by their attempting of many small modifications to the software and performing minimal testing before committing the code to the common repository—this leads to many incorrect behaviors in that code being exposed by other team members that perform more complete software testing. Similarly, the second developer may be identified as thoughtful and disciplined by their making fewer but more extensive code changes that require little modification, and performing a great deal of testing to ensure the software performs as expected before committing it to the common software code repository to be used by all team members.

Presentation of the data can be done in table, event-vs-time, or summary report, or many other formats for data visualization and presentation. Because this data is collected automatically and replaces and exceeds the data collection of manual reporting methods, it offers not only a cost reduction in overhead expense but greater accuracy in developer assessment by team managers.

Embodiments of the invention can also leverage the fact that the data is collected by a distributed database that merges data from any location that has a network connection. This makes the task of managing distributed or remote development teams as straightforward as with local development teams.

### Automated Software Certification System

Developers of computer software face a daunting challenge with conventional development tools and procedures. The conventional methods for debugging software and gaining an intimate understanding of how the software actually works involve a great deal of trial and error and require the developer to mentally simulate the software to understand how it works and more importantly, how it can fail.

One problem is that software defects, also known as ‘bugs’ are usually detected by their external symptoms. During software development, an engineer might notice from external symptoms that a software application is doing something incorrectly. This starts the process of debugging. The developer will then use their familiarity with the software to hypothesize what portion of the software might be the cause of the incorrect behavior. The go-to tool at this point is a Software Debugger, a tool which allows the developer to set a ‘trap’ on a specific condition that is suspected of causing the incorrect behavior. This is known as a breakpoint or a trigger condition.

The program is then run, often repeatedly until the incorrect behavior is exhibited or the debugger's capture condition is matched and a small amount of execution data is obtained. Frequently, the breakpoint will be hit and data captured, but the conditions were not exactly correct to capture the cause of the error. The developer will then modify the conditions to capture data and try again, proceeding in an iterative manner, learning more about what is not causing the error until the correct conditions for capturing the incorrect behavior at the moment it happens can be set up in the debugger.

This is a process that can take a few minutes or several hours for software defects that repeatedly exhibit the incorrect behavior, however some types of software bugs are transient in nature, and only happen under circumstances that are difficult to repeat. These types of defects can be extraordinarily difficult to resolve, and can take days or weeks of effort using highly skilled and expensive resources.

In a software development team environment, conventional software tools force developers to toil in isolation; incorrect behavior that is revealed by one developer is not automatically shared amongst other developers. The process of quality assurance (“QA”) and/or quality control (“QC”) testing and bug-reporting is similarly a time-consuming process; a bug has little chance of being fixed if it cannot be succinctly described in a series of ‘steps to reproduce this bug’ that reliably cause the bug to happen.

A bigger underlying problem with conventional methods of software debugging is that software developers can only fix the bugs they know about. Bugs with subtle symptoms or low recurrence rates are very likely to pass undetected during development and be shipped with the application at product release.

Furthermore, this fundamental lack of visibility causes much difficulty in gaining an understanding of how a software function or application actually works. Software developers are typically expected to take from 3 to 6 months to learn enough details about an unfamiliar software program to become proficient, and even longer to be considered experts.

Software development for safety-critical applications also must often pass rigorous safety certification testing requirements imposed by the FAA, DOT and other U.S. and global agencies. These regulations are enforced to ensure safety, particularly in applications wherein a software defect or fault would run a significant risk of causing catastrophic damage and/or loss of life.

Certification testing is often a time-consuming manual activity that ensures that all executable paths have been run during testing at least once. The certification process for these applications is frequently a tail-end process performed after the software development is complete, and represents significant additional cost and schedule delay while the testing is performed. If any problem areas are discovered, the process can require changes to be made to the software program, necessitating that certification tests are repeated to ensure no regressions have occurred.

Safety certification testing for software will frequently involve tests to ensure and document that all possible software execution paths that existing in the software have been run during testing at least once. This is an exhaustive test that is performed on individual systems using specialized testing apparatus.

One known approach uses a modified software debugger to set software breakpoints on every path branch in the software—this can total tens of thousands of individual breakpoints in the system. The software is then run through a rigorous testing process designed to exercise all of the code, and at every breakpoint the location is noted and that breakpoint is removed from the system. This continues until all breakpoints have been removed, thereby assuring that all paths have been executed at least once. This type of test is performed on individual systems, completely separate from the testing performed during software development and quality assurance tests.

Accordingly, embodiments of the invention use a unique behavioral identification of software execution at the function level as an indexing method for a replayable database of software functions. For every variation in the way a software function is executed a unique identification number is created for that behavior. This identifier is then compared with the contents of a data set such as a database to determine if a match is already present in the data set or if this represents a unique behavior that has not been previously exhibited. If the behavior is new, the identifier and the replayable content of the software execution is added to the data set, otherwise the behavior is simply noted as a repeat of previously-observed behavior.

Leveraging the collection and analysis capabilities of these embodiments also provides an automated approach to certification testing. Because every uniquely executed path is permanently stored in the behavioral database along with the specific build variation of the code exhibiting that behavior, then determining the testing coverage to satisfy a range of certification testing becomes greatly simplified and integral to the software development process.

For example, some embodiments of the invention initiate an analysis of the software program under test to determine every executable code path in the program, as well as the specific build and source code variation of all functions. These embodiments can then query the database for execution behaviors that match those function build and source variants, mapping the paths of those behaviors against the analyzed executable image.

This process creates an initial coverage report for certification testing, immediately highlighting any code segments that have not been adequately tested during development, thereby reducing the remaining testing burden. These paths are tested to satisfy the requirements of certification testing, and appropriate test reports are generated for submission to the appropriate approval agencies.

Accordingly, because embodiments of the invention maintain a continuous database of the path-execution status of all of the software throughout its history, from the earliest stages of development to the conclusion of release testing, a simple query of this database, using parameters to restrict the results to only the release-approved versions of every portion of the software, will produce the same certification testing results that require extensive time and cost to achieve with existing methods. These results can be obtained throughout development and release testing to ensure that testing effort is focused on executing only the remaining untested paths in the software.

For example, a more comprehensive testing method used for flight-critical software in the DO-178B level A testing criterion is ‘Modified condition/decision coverage’ (MC/DC) testing. Software is analyzed to determine every decision point and condition that affects each decision. Testing is then performed on every decision point using all possible conditions. This is normally performed using specialized ‘test harness’ applications that will exercise individual functions in isolation to achieve coverage of the large numbers of required tests.

Embodiments of the invention reduce the testing requirements for MC/DC by continuously accumulating the conditions and results for every decision point in the software program, without requiring any extra steps or specialized test apparatus to be used. It produces a report of the sum total of all tests run on all decision points, for comparison with the MC/DC pre-analysis to help focus testing efforts on untested condition/decision combinations. These tests can then be run manually or as part of an automated testing harness to substantially reduce the total MC/DC testing time.

### Execution Sequence Identification System

Developers of computer software face a daunting challenge with conventional development tools and procedures. The conventional methods for debugging software and gaining an intimate understanding of how the software actually works involve a great deal of trial and error and require the developer to mentally simulate the software to understand how it works and more importantly, how it can fail.

One problem is that software defects, also known as ‘bugs’ are usually detected by their external symptoms. During software development, an engineer might notice from external symptoms that a software application is doing something incorrectly. This starts the process of debugging. The developer will then use their familiarity with the software to hypothesize what portion of the software might be the cause of the incorrect behavior. The go-to tool at this point is a Software Debugger, a tool which allows the developer to set a ‘trap’ on a specific condition that is suspected of causing the incorrect behavior. This is known as a breakpoint or a trigger condition.

The program is then run, often repeatedly until the incorrect behavior is exhibited or the debugger's capture condition is matched and a small amount of execution data is obtained. Frequently, the breakpoint will be hit and data captured, but the conditions were not exactly correct to capture the cause of the error. The developer will then modify the conditions to capture data and try again, proceeding in an iterative manner, learning more about what is not causing the error until the correct conditions for capturing the incorrect behavior at the moment it happens can be set up in the debugger.

This is a process that can take a few minutes or several hours for software defects that repeatedly exhibit the incorrect behavior, however some types of software bugs are transient in nature, and only happen under circumstances that are difficult to repeat. These types of defects can be extraordinarily difficult to resolve, and can take days or weeks of effort using highly skilled and expensive resources.

In a software development team environment, conventional software tools force developers to toil in isolation; incorrect behavior that is revealed by one developer is not automatically shared amongst other developers. The process of quality assurance (“QA”) and/or quality control (“QC”) testing and bug-reporting is similarly a time-consuming process; a bug has little chance of being fixed if it cannot be succinctly described in a series of ‘steps to reproduce this bug’ that reliably cause the bug to happen.

A bigger underlying problem with conventional methods of software debugging is that software developers can only fix the bugs they know about. Bugs with subtle symptoms or low recurrence rates are very likely to pass undetected during development and be shipped with the application at product release.

Furthermore, this fundamental lack of visibility causes much difficulty in gaining an understanding of how a software function or application actually works. Software developers are typically expected to take from 3 to 6 months to learn enough details about an unfamiliar software program to become proficient, and even longer to be considered experts.

Accordingly, embodiments of the invention use a unique behavioral identification of software execution at the function level as an indexing method for a replayable database of software functions. For every variation in the way a software function is executed a unique identification number is created for that behavior. This identifier is then compared with the contents of a data set such as a database to determine if a match is already present in the data set or if this represents a unique behavior that has not been previously exhibited. If the behavior is new, the identifier and the replayable content of the software execution is added to the data set, otherwise the behavior is simply noted as a repeat of previously-observed behavior.

In some embodiments, Real-Time Trace (“RTT”) data alone is used to identify unique execution sequences in a computer—without having any access to the program image, from which functional boundaries could be pre-determined. Although this approach would not be useful by itself for RTT data reconstruction, it would be very useful as an isolated identification system that runs completely separate from the RTT data reconstruction system, and is used to capture RTT data sequences that appear to be unique.

For example, in some embodiments, execution data such as RTT data is captured and analyzed by itself. In this RTT data will appear periodic synchronization messages that report the exact absolute address of program execution at the current instruction. Other RTT messages may also appear, bearing information about specific addresses (such as with branch messages resulting from an indirect branch operation in the software program) and exception entry and exit message that inform when an interrupt or exception has occurred, resulting in the execution of specific handler software.

These messages can frequently serve as boundary indicators, especially for indirect branch messages which can be generated at function call and return events. Some embodiments of the invention can use these key RTT packets to establish the start/stop points for software behavior evaluation, and uses the patterns of instruction and optional data trace messages to determine program behavior.

Further, the periodic sync messages can help verify or establish that an executed pattern is a repeat execution or a new/unique execution pattern. These messages appear roughly every 1000 RTT messages, providing useful insight into what section of software the program is actually executing.

Accordingly, embodiments of the invention can provide methods and systems to:
(1) Evaluate the RTT data packets (without any reference info about the program image)
(2) If a BRANCH message:
   (a) Save and export the previous execution ID and address.
   (b) Initialize a new data object using the new branch address as key value.
(3) If an instruction-executed message: modify the current ID value based on if the instruction executed or was a conditional-non-execute instruction.
(4) If a data access message: modify the ID value based on the operation: read/write, access size, but normally ignoring the data value and address (unless otherwise instructed).
(5) If an exception—start message: save the current ID object in a stack, create a new object for the exception handler code at the passed-in address.
(6) If an exception-stop message: finish and export the current ID and exception handler address.
(7) If a context-ID change message: switch stacks over to a different stack for that context-ID.
(8) If a trace-source-change message: switch stacks over to a different stack area for that source ID.

Using the above steps results in a series of unique execution sequence identifiers for a software application.

### Augmented Trace Data Storage

When saving Real Time Trace (“RTT”) data to a file for later replay, it is expected that a copy of the executable file will be available as well as the source code used in creating that file and the resulting RTT data. However, an isolated snapshot of RTT data lacks needed contextual information—unless that RTT data file was collected from a cold reset of the system. Otherwise, while it's possible to reconstruct where code was executing at the start of the RTT file, it's not possible to determine how the execution got there, what other tasks may have been running, or the contents of their respective call stacks or key areas of system memory.

Accordingly, embodiments of the invention include in the storage of an isolated portion of RTT data some information about the conditions present at the start time of the data recorded in the file. This includes a complete (or substantially complete) representation of the known function call stack(s), and optionally the known contents of memory locations that affect the software execution represented in the RTT file. Statistical, environmental, and session-based information may also be included in this data to help with forensic reconstruction of the conditions present when the code was actually executed.

This data can be presented in snapshot form, typically at the beginning of the file but may also include status at the end of the file. On reconstruction, complete contextual data is available to immediately display what tasks were active before the events in the file, as well as other important details for understanding the reasons behind the data in the trace file of interest.

### Software Debugger Replay “Jukebox”

The creation and development of computer software will usually require the use of specialized tools to aid the software developer in understanding the intimate details of how the software actually behaves at a source- or machine-level. The most common tool for this task is a Software Debugger, a software application that enables the developer to execute specific portions of the software at a greatly reduced rate, with provisions for examining program variables, processor registers and memory, etc. Software debuggers are usually equipped with a common set of facilities to manage the execution of the software: RUN and HALT execution, STEP execution by individual source or machine instructions, and the ability to set breakpoints to halt execution when specific conditions are observed in the target program.

The debugger's ability to RUN/HALT/STEP/EXAMINE can only be performed on the current software program image being run on the computer. Furthermore, only the portions of that program that are actually executed can be observed in the debugger. There are no provisions to recall the results from previous debugging sessions, or to recall the results from previous iterations of the program in development. These things can be done with a software debugger, but only if the previous program image, source files, and all conditions during execution are carefully reconstructed and re-run, and even then it will not guarantee that the results will be identical to the previous debugging sessions.

For the software developer that seeks answers to basic questions such as: “How does this code work?,” “How did this function work before the last change?,” “What does this section of code actually do?,” etc., the quest to find answers is very time-consuming using conventional debuggers. Even the newest ‘Replay Debuggers’, which provide the ability to STEP and RUN forwards or backwards through a just-collected ‘trace’ file of execution data do not maintain visibility beyond the data that was most-recently collected. Any changes in program image, or starting a new data collection session will cause the tool to lose the previously-collected data, leaving the developer no other choice but to recreate and re-run the software program of interest to get the answers they need.

Accordingly, embodiments of the invention provide a “Jukebox” of software execution information that can be replayed on-demand using a replay debugger. The replay abilities include all source code changes, program image changes, and execution sessions of when the software was actually run on the computer. This makes the replay of any collected software execution be immediately available on-demand to a software developer and eliminates the need to manually revert to earlier versions of software source code, executable images, and to manually re-run the software.

Embodiments of the invention provide many benefits to the software developer over existing tools: 1) Developers can quickly gain expertise with unfamiliar software. This is helpful to experienced developers that have been assigned more responsibilities, but is particularly helpful to newly-hired developers that have no familiarity with a software code base. A newly-hired developer is normally expected to take anywhere from 3 to 6 months to become proficient with a software code base. 2) An on-demand historical reference of the software is created automatically. This helps to understand the reasons for changes to the code, and the performance and functional tradeoffs that have happened as a result.

For example, embodiments of the invention turn the ‘how it actually works’ knowledge of software into a tangible business asset. Knowledge of how the software works is presently contained only in the minds of the software developers that have painstakingly learned of its subtleties through many hours spent with a software debugger. This knowledge cannot be efficiently transferred to others, cannot be backed-up to additional copies for safekeeping, and cannot be sold or owned by a business entity. Embodiments of the invention assemble this information into a “knowledge base” that can be archived, copied, stored, sold, and owned by a business entity or individual.

Embodiments of the invention use execution data obtained from a software execution environment that is capable of exporting execution trace information that is suitable for replay reconstruction. Examples of such information include but are not limited to: real-time trace data from a microprocessor, execution trace data from a simulation environment, logging data from a computer program, etc.

One embodiment of the invention provides systems and methods for:
(A) capturing and storing the execution trace data.
(B) capturing and storing the software source code used to create the target software program.
(C) capturing and storing the target software program image or representative data thereof
(D) analyzing or annotating the collected execution trace data to identify sections of interest for later recall.
(E) reconstructing the execution trace data in a replay debugger.
(F) providing a replay debugger.

In some embodiments, Item D provides meaningful indexing but is optional. Also, in some embodiments, Items E and F are provided by externally-provided facilities. However, in many embodiments, the methods and systems include Items A-F, would save the collected data in a bulk-storage medium such as a database or file system, and would analyze the content of the execution data and source and executable files to detect changes and create meaningful indexes to the data set for on-demand replay.

The indexing tags may be created through analyzing execution path, timing profiling, program parameters, and other analyses either alone or in combination. This analysis can also be used to reduce the quantity of execution trace data stored, as repetitive sequences or sections noted as do-not-save would be eliminated from the data storage set. This is an optimization to reduce storage requirements.

The source files and executable program images are similarly analyzed for location and scope of content changes as an aid for indexing and to avoid unnecessary duplication of files in the data set, since every source file would be needed for every unique build of the program image, but not every source file will have changed from build to build. Again, this is an optimization to reduce storage requirements.

Accordingly, embodiments of the invention can provide a system for collecting not only the execution trace data, but also the software source and executable files thereby facilitating on-demand replay. The addition of meaningful indexing produces the results of on-demand accessibility to any characteristic portion of the executed software of interest, at any point in its recorded history

### Software Execution Anomaly Detector

Critical software systems, such as avionics, automotive, industrial automation, infrastructure control, and internet systems are expected to run flawlessly, and are an irresistible target for hackers and other threats. Far too often, a defect or exploited vulnerability will go undetected for long periods of time, leaving the attacker with open access to these systems.

This is because of the invisible nature of software execution; it runs invisibly inside the computer system, revealing only the defects that rise to the level of creating externally-detectable symptoms. Advances in software development tools have produced the ability to characterize the behavior of individual functions in systems executing at full speed. This characterization is done during software development to produce software that is deemed fit for release, after which point the software is expected to run in the world at large in the same manner as in a controlled development environment.

Software development can scarcely anticipate every condition that will be encountered in a field deployment of the software. For critical systems, this leaves a large vulnerability that endangers those that depend on these systems.

Accordingly, embodiments of the invention compare behaviors of a field-deployed software program with a previously-constructed database of known, approved behaviors, to immediately detect any previously unobserved behaviors as they happen, thereby enabling corrective and diagnostic actions to be immediately taken.

For example, embodiments of the invention performs the same continuous analysis of the software execution—using real-time trace, profiling, instrumentation, etc.—as was used during software development and testing to create in real-time a series of behavioral identifiers for the function-level components of the software program to be monitored. These identifiers are compared with a known-good dataset of reference behavioral identifiers for every software function. If no match is detected (anomaly), then action can be immediately initiated to do any or all of the following: isolate the offending code, isolate the external network connection, reset the system, move the anomaly and connection into an isolated “sandbox” to allow further progression for analysis, and to record and save all relevant information about the anomaly for analysis by software developers or security researchers.

The database of known-good behaviors is assembled and reviewed during software development and release testing, after performing exhaustive testing of all expected operating conditions.

### Hybrid Software Real-Time Trace System

Real-time trace (“RTT”) of software execution has been in use for over 30 years. RTT exports from a computer system the details about what software code is being executed, and optionally the values and locations of program variables. This data is exported cycle-by-cycle from a computer that is running at full execution speed, and without any additional instructions added to facilitate the export of this data.

The drawback to implementing RTT is that it must export a very large amount of data, especially when exporting program variables and their locations. Current RTT systems can achieve 1 bit per instruction for instruction-only export, but require 4 per instruction plus 40 bits per data value to include the export of program variables. For a computer system that can execute 100 million instructions per second, this results in an easy to achieve 12.5 megabytes per second export requirement for instruction trace only, but over 200 megabytes per second export is required to include program variable export on an average program.

For example, RTT ports come in two basic configurations: instruction-only and instruction-plus-data. The two configurations will be explained using the following example pseudo code:

[START FUNCTION, value A and value B are passed to function
via call stack (in memory)]

Add 20 to value A
Shift value A to the right by 2 bits
Logical-or value A with value B to get intermediate value X
If bit 0 of value X is == 1 skip the next 2 instructions
Invert value B
Add 1 to value B
Logical-XOR value A and value B to get value C
Subtract 20 from value A
Multiply value A by value C to get new value C
Return value C via call stack (in memory)

To export instruction-only trace information, logic establishes and maintains where code is executing and how many instructions are executed or conditionally not-executed. By comparing this information to a reference copy of the software that is being executed, full instruction-only reconstruction can be performed. This reconstruction doesn't take very many bits of information per instruction to export via RTT. For instance, as low as 0.5 bits of information per instruction can be exported. Accordingly, the function above could be instruction-only traced by exporting as few as 4 bits using instruction-only RTT.

Using RTT instruction-only export provides information about what instructions were executed, but provides little to no visibility into the values of the program variables. These values can also be exported through the RTT port, but it is costly in terms of information capacity than instruction-only export. For example, it can take an average of 20 bits to export each variable, and exporting this information can decrease the efficiency of instruction trace export to about 4 bits per instruction. Accordingly, the above function could be instruction- and data-traced by exporting 84 bits.

Also, “data trace” can be a misnomer because a “data trace” is really a “memory access trace.” In particular, a “data trace” typically only exports the program variables if/when they are READ or WRITTEN to/from memory (it will export both the address in memory and the value of the data that is being read/written). For example, in the above example, the values A and B, and the result C would be exported via RTT because they're passed on the call stack—in memory. Intermediate values, however, such as the result of the instruction “Add 20 to value A,” can be reconstructed by simulating the instructions that are known to have executed on the passed-in program variables. So again, with the help of some simulation, a complete reconstruction of the function can be obtained.

However, embodiments of the invention provide a “hybrid trace.” For example, since the program data values are being read/written to memory, why export them through the RTT port if there is an externally-accessible memory bus that could be monitored to obtain these values? Accordingly, embodiments of the invention capture these external memory-bus values and the instruction-only RTT data from the RTT port and correlate the data together to achieve approximately the same results as an instruction+data RTT solution with only the RTT export requirements of an instruction-only RTT port.

Some processors have internal cache memory (e.g., 1, 2, or 3 levels of cache memory) before the data is flushed to external memory that would be observable by this invention. Also, processors have external I/O ports (such as Ethernet, USB, etc.) that can be observed to obtain valuable data for RTT reconstruction—but how can the processor keep track of which values to not export via the RTT port? As described above in the section titled “System and Method of Software Execution Trace Data Reduction,” the processor can include circuitry configured (e.g., by the RTT/debugging equipment) to indicate which external buses are being monitored by setting a “RECONS” or “visible” bit that accompanies all data values that enter through those ports, or are destined to be exported through those ports. As described above, “visible” data values do not need to be exported through the RTT port, but if they're combined with a “not visible” variable (thereby making their value ambiguous to external reconstruction), the “visible” bit is cleared and they are a candidate for RTT export. Therefore, some embodiments of the invention look for opportunities to avoid exporting RTT data values when they're available by other means that are already outside of the processor package and can be collected/correlated/reconstructed by a debugging tool.

Accordingly, embodiments of the invention reduce export burden by taking advantage of already-external sources of visibility into program variables. For example, some embodiments of the invention monitor an external memory bus of a microprocessor that includes RTT for instructions only. All transfers that take place on this external bus will be driven by the actions of the software running inside the device, as indicated by the export of the RTT information from the device. Therefore, embodiments of the invention collect and decode the RTT instruction-only data to determine the flow of instructions as the software program executes and correlates the RTT data to the data collected by monitoring the external memory bus from the device.

Further, embodiments of the invention optionally employ an instruction set simulator (“ISS”) to assist in the reconstruction and correlation of collected external data to the collected RTT data. This is important when monitoring the external memory bus of a processor that includes an on-chip cache for program variables and data. These variables might reside in the on-chip cache for extended periods, invisible to outside monitoring devices until they become inactive within the software execution and they are flushed from the on-chip cache during a write-back operation to external memory. In this case, there would be visibility into the variable's value when it was read from main memory into the on-chip cache, there would be full visibility into the operations that were performed on the data value while it resided in on-chip cache, and there would be visibility into its final value when it was written-back to external memory. An instruction set simulator could assist in reconstructing the intermediate values of this program variable at each step of execution while it resided in on-chip cache.

Not every processor includes an external memory bus. For many microcontrollers, all program and data memory resides on-chip, and the external pins of the device are used for other types of buses such as Ethernet, USB, CAN, I2C, etc. Embodiments of the invention can use the same approach to capture these external signals along with the RTT data, then decode the data and use simulation capabilities to correlate and determine the values of internal program variables, thus providing much of the visibility into software execution that is obtainable with a high-export-requirement RTT port with program variable export, yet only using a low-export instruction-only RTT port.

Embodiments of the invention can be retrofitted to existing RTT ports with limited capabilities and provides an option of additional logic to be implemented into an enhanced RTT port design. This adds a “visible” bit to program data values to indicate to the RTT export system if that data value is externally visible in the present configuration. This bit will be set according to configuration rules that are provided by an attached RTT debug and monitoring system, so if for example a target processor system had monitoring equipment on its Ethernet port, the equipment would set the ‘visible’ rule for all data that flows through this port, thereby making it unnecessary to export those program variables through the RTT port.

Additional on-chip logic provides a determination of the visibility of program variables as they are operated on by the executing software. For example, if a ‘visible’ program variable is combined with a ‘non-visible’ variable through an executed arithmetic or logical operation, the result will also be ‘non-visible’ and therefore subject to export. This additional ‘visible’ bit would be used for all peripherals and on-chip memory locations, and in the CPU logic for performing instruction operations. Additionally, embodiments of the invention provide logic to set or clear the ‘visible’ bits in memory. This could be used to disable or force the export of data values through the RTT port, and could be done periodically or on-demand by a connected software analysis/debug system.

The reduction in data export, weighed with the increase in software program execution visibility against the relatively small cost of silicon and transistors makes the tradeoff more compelling. For example, the combination of external signal visibility and on-chip selectivity to export through the RTT port only the program variables that would otherwise be invisible to external reconstruction that produces the greatest visibility at the lowest cost in RTT port pins and data export requirements.

Various features and advantages of the invention are set forth in the following claims.

What is claimed is:

1. A method of analyzing execution data for software, the method comprising:
storing, by a processing unit, execution trace data for the software when the software is executed;
storing, by the processing unit, source code for the software when the software is executed;
storing, by the processing unit, a program image of the software when the software is executed; and
replaying the execution of the software using the execution trace data, source code, and the program image.

2. The method of claim 1, further comprising indexing the execution trace data.

3. A method of identifying defects in software, the method comprising:
executing a function included in the software along an execution path;
determining, by a processing unit, an identifier for the execution path, wherein the identifier uniquely identifies the execution path as compared to other execution paths for the function;
accessing a database of previously-determined identifiers associated with known execution paths of the function;
comparing the identifier with the database to determine if the database includes the identifier;
when the database does not include the identifier, storing the identifier to the database; and
when the database includes the identifiers, not storing the identifier to the database.

4. The method of claim 3, wherein determining an identifier for the execution path includes determining an identifier based on at least one selected from the group consisting of a timing measurement, an execution address, an action performed on a data object, and real-time trace data.

5. The method of claim 3, further comprising storing execution data associated with the path of execution associated with the identifier.

6. The method of claim 5, further comprising using the stored execution data to replay the path of execution.

7. The method of claim 3, further comprising allowing a user to review each identifier included in the database and receive a classification of each identifier as being associated with a valid execution path or a defective execution path.

8. A method of collecting execution trace data for software, the method comprising:
receiving execution trace data from a data source at a cascade port;
portioning the received execution trace data into a first portion and a second portion;
routing the first portion to an internal memory for processing; and
routing the second portion over a connector to a second cascade port.
